(19) United States
(12) Patent Application Publication
(10) Pub. No.: US 2010/0085653 A1
(43) Pub. Date: Apr. 8, 2010

(54) MIRROR ASSEMBLY FOR VEHICLE

(75) Inventors: John T. Uken, Jenison, MI (US); William K. Boezwinkle, Grand Haven, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: MAGNA MIRRORS OF AMERICA, INC., Holland, MI (US)

(21) Appl. No.: 12/558,892

(22) Filed: Sep. 14, 2009

Related U.S. Application Data
(60) Provisional application No. 61/097,049, filed on Sep. 15, 2008.

(51) Int. Cl. B60R 1/04; B60R 1/12

(52) U.S. Cl. 359/872

(57) ABSTRACT

An interior rearview mirror assembly suitable for use in a vehicle includes a mirror casing, a prismatic reflective element at said mirror casing, a toggle device at said mirror casing, and a circuit element. The toggle device includes a user actuatable element and is operable in response to the user actuatable element to pivot the prismatic reflective element between a day state orientation and a night state orientation. The circuit element has electronic circuitry disposed on a substrate, and has an electrical connector extending from the substrate. The electrical connector extends through a portion of the toggle device and is accessible through the generally central region of the rear wall of the mirror casing.

### CROSS REFERENCE TO RELATED APPLICATION

The present application claims the benefit of U.S. provisional application Ser. No. 61/097,049, filed Sep. 15, 2008, which is hereby incorporated herein in its entirety.

### FIELD OF THE INVENTION

The present invention generally relates to an interior rearview mirror assembly and, more particularly, to an interior rearview mirror assembly having circuitry therein and an electrical connector.

### BACKGROUND OF THE INVENTION

It is known to provide electronic circuitry in an interior rearview mirror assembly of a vehicle. Typically, the circuitry is disposed on a printed circuit board supported within the mirror casing. Electrical power and optionally control of the circuitry is provided via a wired connection to the mirror assembly. Typically, the wired connection connects to the mirror circuitry via a multi-pin electrical connector toward a side of the rear portion of the mirror casing, such as toward the passenger side of the mirror assembly when the mirror assembly is normally mounted in a vehicle.

### SUMMARY OF THE INVENTION

The present invention provides an interior rearview mirror assembly of the vehicle that has a prismatic reflective element, a toggle device or mechanism for toggling or “flipping” the reflective element between a daytime or higher reflectivity orientation and a nighttime or reduced reflectivity orientation, and circuitry having an electrical connector at a rear casing of the mirror assembly for connecting the mirror circuitry to power and/or control circuitry of the vehicle. The electrical connector is generally centrally located at the rear of the mirror casing and extends through or near the toggle body of the toggle device of the prismatic reflective element.

According to an aspect of the present invention, an interior rearview mirror assembly includes a mirror casing, a prismatic reflective element at the mirror casing, a toggle device at the mirror casing and a circuit element. The toggle device comprises a user actuatable element (such as a tab or the like disposed at or extending from a lower region of the mirror casing) and is operable in response to actuation or movement of the user actuatable element by a user to pivot the prismatic reflective element between a day state orientation and a night state orientation. The circuit element has electronic circuitry disposed on a substrate, and includes an electrical connector extending from the substrate. The electrical connector extends through the generally central region of the rear wall of the mirror casing and through a portion of the toggle device for connection to a vehicle wire or wire harness or other suitable vehicle-based wiring connection.

Optionally, the toggle device may comprise a mounting member configured to adjustably mount the mirror assembly to a mounting structure attached to the vehicle, and with the mounting member being generally centrally located at the mirror casing. Optionally, the mounting member extends through an aperture formed through the generally central region of the rear wall of the mirror casing. Optionally, the aperture is established generally adjacent to or at or above the aperture for receiving the electrical connector. Optionally, the toggle device comprises a biasing element that comprises a flexible loop portion of the toggle device, with the flexible loop portion being configured to receive the electrical connector therethrough.

These and other objects, advantages, purposes and features of the present invention will become apparent upon review of the following specification in conjunction with the drawings.

### BRIEF DESCRIPTION OF THE DRAWINGS

FIG. 1 is a front perspective view of a mirror assembly in accordance with the present invention;

FIG. 2 is a rear perspective view of the mirror assembly of FIG. 1;

FIG. 3 is a rear perspective view of a rear casing and toggle mechanism of the mirror assembly of the present invention;

FIG. 4 is a rear plan view of the mirror assembly of FIG. 3;

FIG. 5 is a front perspective view of the mirror assembly of FIG. 3;

FIG. 6 is a front exploded perspective view of the mirror assembly of FIG. 5;

FIG. 7 is a top exploded plan view of the mirror assembly of FIG. 5;

FIG. 8 is a front perspective view of the rear mirror casing of the mirror assembly of the present invention;

FIG. 9 is a front plan view of the mirror casing of FIG. 8;

FIG. 10 is a perspective view of the circuit element and connector of the mirror assembly of the present invention;

FIG. 11 is a top plan view of the circuit element and connector of FIG. 10;

FIG. 12 is a rear plan view of the circuit element and connector of FIG. 10;

FIG. 13 is a perspective view of the toggle device of the mirror assembly of the present invention;

FIG. 14 is a rear plan view of the toggle device of FIG. 13;

FIG. 15 is a rear perspective view of another mirror assembly in accordance with the present invention;

FIG. 16 is a front perspective view of the mirror assembly of FIG. 15, with the reflective element removed therefrom to show additional details; and

FIG. 17 is an exploded perspective view of the mirror assembly of FIGS. 15 and 16.

### DESCRIPTION OF THE PREFERRED EMBODIMENTS

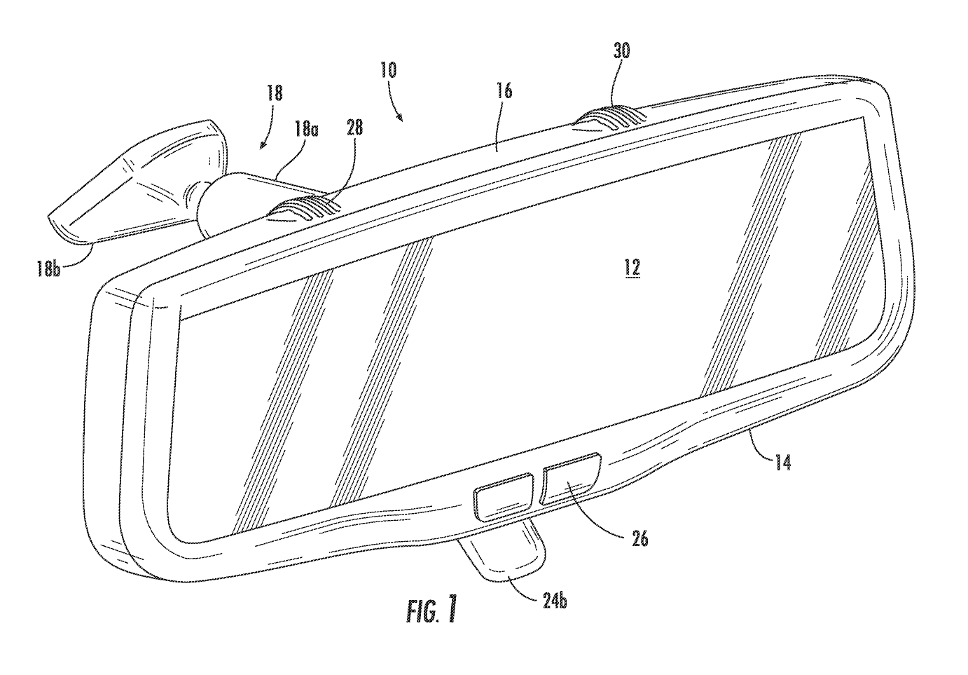

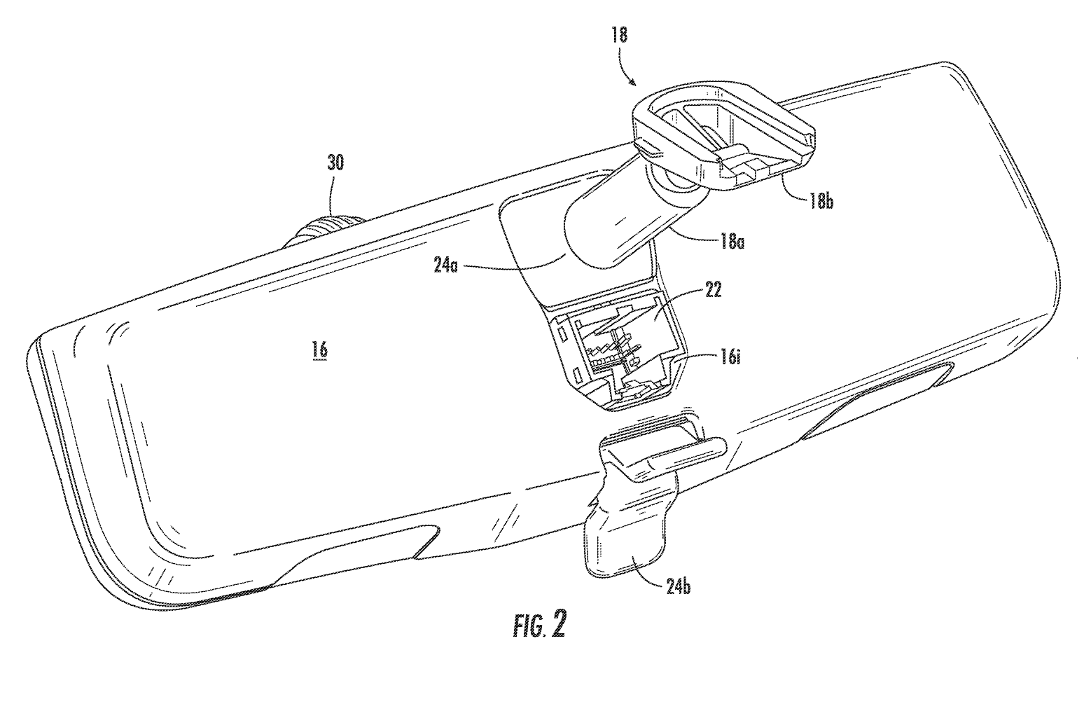

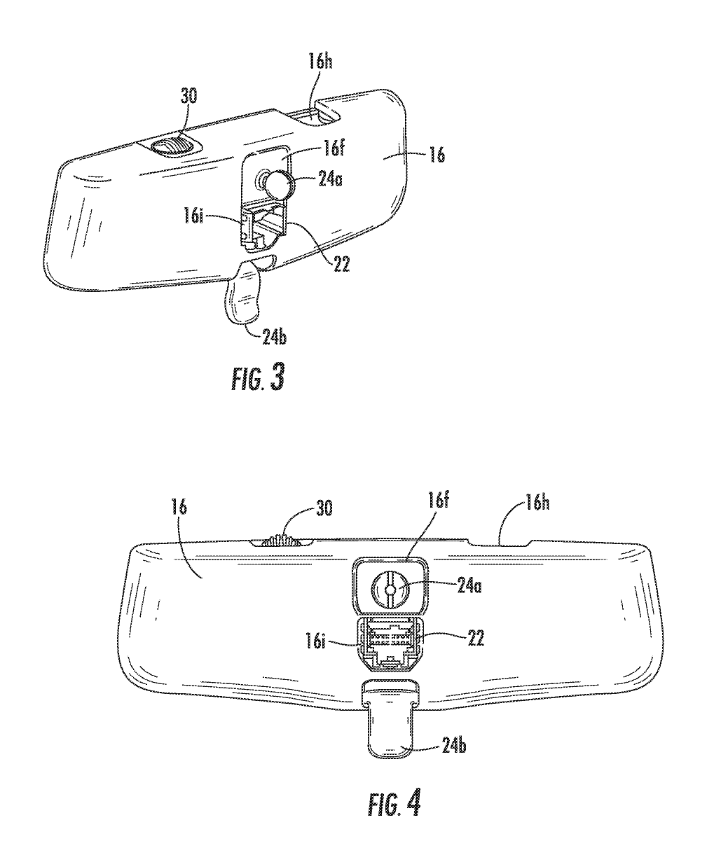

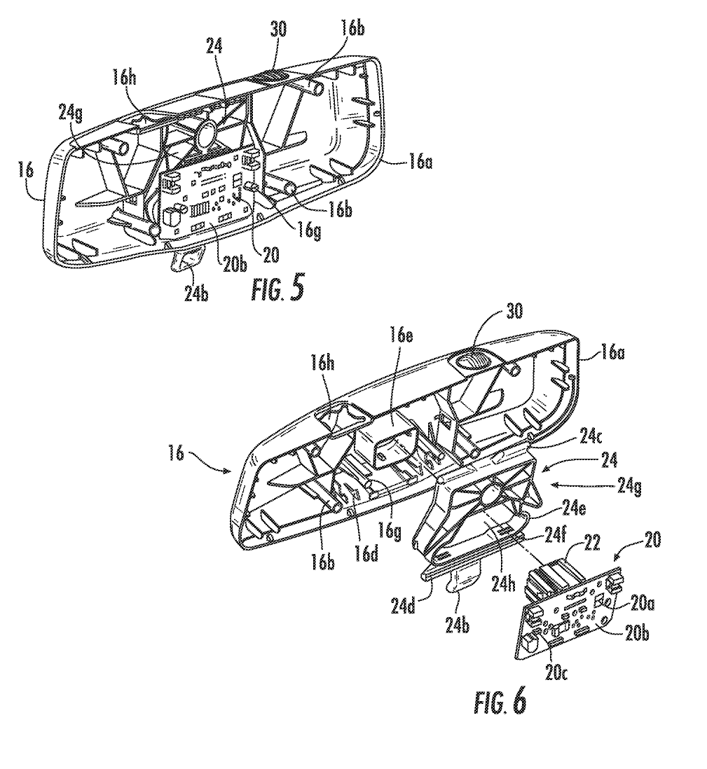

Referring now to the drawings and the illustrative embodiments depicted therein, an interior rearview mirror assembly 10 is mounted at an interior portion of the vehicle, such as to an interior surface of the vehicle windshield or to another mounting structure in the interior of the vehicle (FIGS. 1 and 2). The interior rearview mirror assembly 10 includes a reflective element 12, a bezel portion 14 that receives and/or supports the reflective element 12, a rear casing or housing portion 16 and a mounting structure 18, such as a double ball mounting structure that movably and adjustably supports the mirror assembly and reflective element at the interior portion of the vehicle. The mirror assembly 10 includes electrical circuitry 20 (FIGS. 5-7), which includes or is electrically connected to an electrical connector 22, which is disposed at a generally central location at the rear casing 16, whereby an electrical wire or wiring harness or lead of the vehicle may be connected to the electrical connector 22 generally at and below the mounting structure 18 of the mirror assembly, as discussed below. The electrical connector 22 extends through a portion of a toggle device 24 (FIGS. 5-7) that is adjustable by a user to adjust the mirror reflective element between a day state orientation or higher reflectivity orientation (where the reflective element is adjusted or set to reflect a greater percentage of light incident thereon toward the driver of the vehicle) and a night state orientation or lower reflectivity orientation (where the reflective element is adjusted or set to reflect a lower percentage of light incident thereon toward the driver of the vehicle), as also discussed below.

In the illustrated embodiment, mirror assembly 10 includes a prismatic reflective element 12 and is adjustably mounted to the interior surface of a windshield of the vehicle via the mounting structure or mirror support structure 18. Optionally, the mounting structure 18 may mount or attach to the vehicle windshield via a conventional channel mount or mounting button, such as described in U.S. Pat. Nos. 5,820,097; 5,487,522; 5,671,996; 5,820,097; 5,615,857; 5,330,149; 5,100,095; 4,930,742, which are hereby incorporated herein by reference in their entireties, which may provide a break-away mounting or release mechanism as is known in the art. Although shown and described as being mounted to the vehicle windshield, it is envisioned that, optionally, the mirror assembly may be located or attached elsewhere at the vehicle, such as at an overhead console or headliner of the vehicle or the like. Optionally, the mounting structure may mount to the windshield and/or headliner and/or overhead console or the like via other suitable mounting means, such as by utilizing aspects of the mounting elements described in U.S. Pat. No. 6,824,281; 5,487,522; 5,615,857; or 5,671,996, and/or U.S. patent application Ser. No. 10/958,087, filed Oct. 4, 2004 by Schofield et al. for VEHICLE ACCESSORY MODULE, now U.S. Pat. No. 7,188,963; and/or Ser. No. 11/226,628, filed Sep. 14, 2005 (Attorney Docket DON01 P-1236), which are hereby incorporated herein by reference in their entireties.

In the illustrated embodiment of FIGS. 1 and 2, support structure or mounting structure 18 comprises a double ball mounting or support structure and includes a support arm 18a that is pivotally attached to a ball member 24a of toggle device 24 and to a mirror support base 18b. The mirror support base 18b may be mounted to an interior surface of the vehicle windshield, such as at a conventional or known channel mount or mounting button (typically adhered or bonded to the interior surface of the windshield of the vehicle, such as in a manner known in the vehicle mirror art). The mirror head or casing and reflective element and toggle assembly thus may be pivoted relative to the windshield to adjust the rearward field of view of the driver via the mirror reflective element 12, such as is known in the automotive mirror art.

Optionally, the mirror assembly may include wire management elements, such as the types described in U.S. patent application Ser. No. 11/226,628, filed Sep. 14, 2005 (Attorney Docket DON01 P-1236); and/or Ser. No. 11/584,697, filed Oct. 20, 2006 (Attorney Docket DON01 P-1296); and/or U.S. provisional application, Ser. No. Ser. No. 60/729,430, filed Oct. 21, 2005, which are hereby incorporated herein by reference in their entireties, to conceal the wires extending between the electrical connector at the mirror casing and the vehicle headliner (or overhead console). Optionally, the mirror casing and/or mounting structure may abut the headliner and/or may be an extension of an overhead console of the vehicle (such as by utilizing aspects described in U.S. patent application Ser. No. 10/538,724, filed Jun. 13, 2005 by Hutzel et al. for ACCESSORY SYSTEM FOR VEHICLE (Attorney Docket DON01 P-1123), and/or U.S. patent application Ser. No. 10/510,813, filed Aug. 23, 2002 by Berberich et al. for COVER MODULE, now U.S. Patent Application Publication No. US2005/0151396A1, published Jul. 14, 2005, which are hereby incorporated herein by reference in their entireties). The mirror assembly of the present invention thus may allow for utilization of the area above the mirror reflective element for additional mirror content, such as additional electronic accessories or circuitry, and thus may provide for or accommodate additional mirror content/circuitry and/or vehicle content/circuitry.

Mirror reflective element 12 may be formed from various materials such as plastic or glass, but preferably is glass, and preferably has a planar front surface extending at an angle to a planar rear surface. The rear surface is coated with a reflective layer of metal, such as, for example, chromium, aluminum or alloys thereof, such as may be conventionally known in the industry. Mirror assembly 10 is pivotable relative to mounting assembly 18 to pivot the reflective surface of reflective element 12 in order to reduce glare during nighttime conditions. When mirror assembly 10 is pivoted from a full reflectivity day position to a reduced reflectivity night position, the reflective surface of reflective element 12 is rotated or pivoted or adjusted such that uncoated front surface of the reflective element is aligned for viewing by the vehicle driver instead of rear reflective surface of the reflective element 12. Preferably, the rear reflective surface reflects at least about 60 percent to about 95 percent of the light incident thereon, while the uncoated front surface reflects about 4 percent of the light incident thereon, thereby significantly reducing glare from headlights or other bright lights to the rear of the vehicle to the driver's eyes.

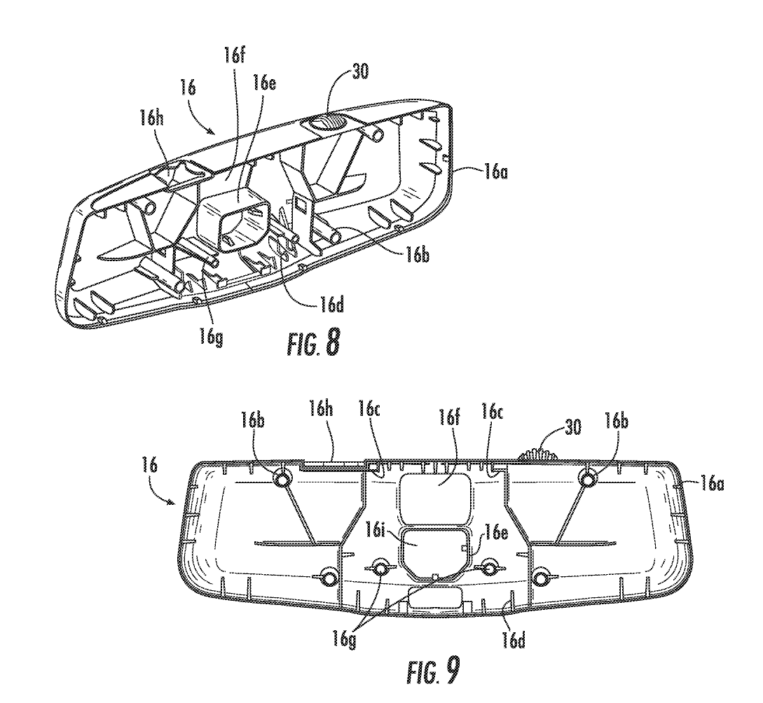

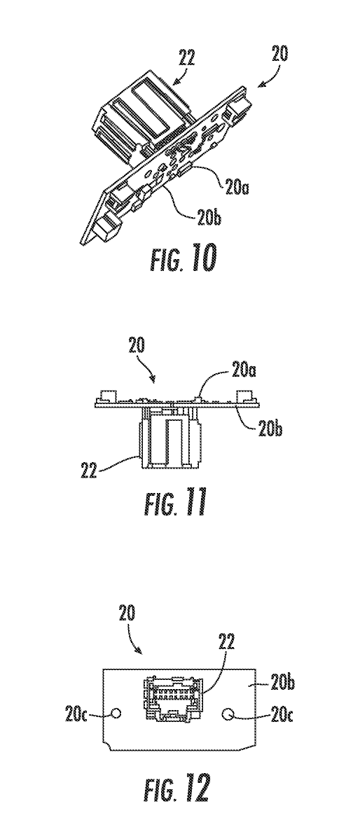

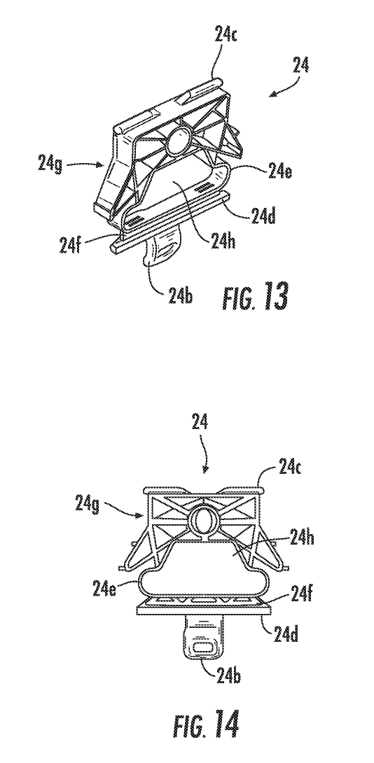

Mirror casing 16 includes a forward edge or lip 16a for attaching to the mirror bezel 14 to support the reflective element 12 at the forward portion of the mirror casing. The mirror casing 16 also includes a plurality of stand-offs or stanchions 16b for attaching to the mirror backplate of the reflective element 12 to securely retain the reflective element 12 relative to the mirror casing 16. As can be seen with reference to FIGS. 6 and 9, mirror casing 16 includes axle receiving portions 16c, 16d for receiving upper and lower axles or pivot arms of the toggle device 24, as discussed below. A receiving portion or wall 16e is formed at a generally central region of mirror casing 16 (and at least partially defines or circumscribes or encompasses an aperture 16i through the rear wall of the mirror casing) and generally below an aperture 16f (formed through the mirror casing) for the mounting ball member 24a of toggle device 24, with the receiving portion 16e being established to receive the electrical connector 22 therein, as also discussed below. The apertures 16f, 16i may be adjacent to one another or may be spaced apart at the rear wall of the mirror casing, or may comprise a single aperture established through the mirror casing for receiving the ball member and the electrical connector at least partially therethrough.

The toggle device or ball and toggle assembly 24 is pivotally mounted within the mirror casing 16 and comprises a ball member 24a that extends through an aperture or opening 16f at the rear of the casing 16 for attaching to or being received in a socket element of a mounting arm 18a of mounting structure 18. Toggle device 24 includes a user actuatable input or toggle actuator or flip element or tab 24b, which extends from the bottom of mirror assembly 10, and which is configured such that a user may actuate or move the tab 24b to toggle or flip or pivot the mirror casing 16 and prismatic mirror reflective element 12 relative to the mounting base 14 and to a driver of the vehicle and between the higher reflectivity and lower reflectivity orientations. The ball member 24a and mounting arm 18a of mounting structure 18 provide a substantially secure, yet pivotal connection or joint to allow pivotal movement of mirror assembly 10 relative to the mounting structure and the vehicle windshield, while retaining mirror assembly 10 in a desired position. The frictional resistance between the ball member and a corresponding socket of the mounting arm allows for manual pivotal movement of mirror assembly 10 relative to the arm by an operator or passenger of the vehicle, yet resists movement of the ball member at the mounting arm in the absence of manual intervention. Toggle device 24 may utilize aspects of the toggle devices described in U.S. Pat. No. 6,318,870, which is hereby incorporated herein by reference in its entirety.

In the illustrated embodiment, toggle device 24 is mounted within the interior cavity of mirror casing 16 via an upper pivot pin or axle 24c that is pivotally received in corresponding receiving portions 16c of mirror casing 16. Toggle device 24 also includes a lower pivot pin or axle 24d that is received in corresponding receiving portions 16d of mirror casing 16, and further includes a biasing member 24e and a living hinge 24f. The upper pivot pin 24c and ball member 24a are disposed at a body portion 24g of toggle device 24, with the biasing member 24e and living hinge 24f and lower pivot pin 24d being disposed at a lower portion of the body portion 24g. Optionally, toggle device 24 may be integrally or unitarily formed as a unit such as via polymeric injection molding or the like, and an aperture 24h is established through biasing member 24e by the forming process or injection molding process.

As is known in the art, the upper pivot pin or axle 24c is pivotally received in one or more correspondingly formed supports, such as grooves or clips 16c at an upper wall of mirror casing 16 via a snap-fit connection, while lower pivot pin or axle 24d is similarly pivotally received in one or more correspondingly formed supports, such as grooves or clips 16d, at a lower wall of mirror casing 16. By pivoting toggle arm or tab 24b between a rearward, day position and a forward, night position, the toggle device 24 is operable to pivot mirror casing 24 relative to the mounting structure 18 about upper pivot pin 24c via pivotal movement of lower pin 24d and corresponding pivotal or translational movement of the lower portion of the toggle device via living hinge 24f. The separation distance between the upper and lower receiving portions 16c, 16d of mirror casing 16 is such that the biasing member or element 24e of toggle device 24 is partially compressed when tab 24b is positioned centrally between the day position and the night position, and thus exerts a biasing force at the living hinge to bias and retain the tab 24b in one of the two positions.

The biasing member or element 24e of toggle device 24 comprises a flexible, generally oval-shaped member. As a lower portion of biasing member 24e is moved toward or away from the lower pivot arm 24d via pivotal movement of the lower pivot arm and corresponding movement of the living hinge 24f that is disposed between lower pivot arm 24d and biasing member 24d, the curved sidewalls of biasing member 24e flex to allow relative movement between the lower portion and upper portion of the biasing member. The curved side portions are biased in an initial orientation that generally corresponds to the day or night positions, such that they function to exert a biasing force on the lower portion of the biasing member as it is moved via actuation of the actuating tab 24b between the day position and the night position.

Biasing member 24e is formed with an aperture 24h to receive electrical connector 22 therethrough so that electrical connector is generally centrally located at the rear of the mirror casing and generally below the ball member 24a of the toggle device 24. In the illustrated embodiment, the receiving portion or wall 16e of mirror casing 16 extends at least partially through the biasing member 24e for receiving and supporting the electrical connector 22 at the rear mirror casing 16. Optionally, the receiving portion 16e may include tabs or retaining elements for engaging corresponding retaining elements of the electrical connector 22 to secure and retain the electrical connector relative to the mirror casing 16.

In the illustrated embodiment, circuit element 20 comprises a printed circuit board (with electrical circuitry 20a disposed at a rigid substrate 20b that is mounted to mirror casing 16 and/or reflective element 12), with electrical connector 22 fixedly secured to the substrate 20b and extending rearwardly therefrom. In the illustrated embodiment, electrical connector 22 comprises a multi-pin connector having a plurality of terminals or pins (such as 16 as shown, or such as more than 16 or less than 16 depending on the particular application of the mirror assembly and the electrical content of the mirror assembly). The electrical connector may be a plug or socket type connector that is adapted to be received in or to receive a corresponding socket or plug type connector, such as a connector at an end of a vehicle wire harness that provides electrical power or voltage and/or control signals to one or more accessories of the mirror assembly). Optionally, the electrical connector may be fixedly secured to the circuitry substrate or may be otherwise attached to or in electrical communication with the circuitry or circuit element while remaining within the spirit and scope of the present invention. Optionally, the electrical circuitry may comprise a printed circuit board or may comprise any other suitable form of electrical circuitry and may have circuitry elements disposed on a flexible substrate or other support means while remaining within the spirit and scope of the present invention. As can be seen in FIG. 6, substrate 20b of circuit element 20 may have one or more apertures 20c formed therethrough for receiving mounting stanchions or arms 16g of mirror casing 16 to support and secure the circuitry element at the mirror casing.

When the toggle device is received in or mounted at the mirror casing, the elongated connector passes through the aperture of the toggle device and through or at least partially through the aperture at the rear wall of the mirror casing. Thus, and as can be seen with reference to FIG. 6, the circuit element or circuit board is at least partially disposed between the toggle device and the rear surface of the mirror reflective element. The connector extends from the circuit element through the apertures so as to be accessible at the rear of the mirror casing for electrical connection thereto.

Thus, the mirror assembly 10 provides an electrical connector that extends through an aperture of the toggle device and through an aperture of the rear casing so as to provide for electrical connection at a generally central location at the rear of the mirror casing and generally below the mounting ball of the mirror assembly. Also, the circuit board or element may be disposed generally centrally within the mirror assembly, and thus may be located behind user inputs or buttons 26 (FIG. 1) at the generally central region of the bezel portion 14, without requiring a separate leg or extension of the circuit board toward a side of the mirror assembly to connect to a sidewardly positioned connector of the prior art. Thus, the circuit element may comprise a generally centrally mounted circuit element with the electrical connector fixedly mounted to the substrate or circuit element, which may provide a cost efficient circuit element that may be readily installed in the mirror casing (such as by snapping the circuit element to the walls at the rear of the mirror casing, with the circuit element or substrate being disposed between the mirror reflective element and the toggle device). The mirror assembly thus provides a generally centrally located circuit element and connector in a location that heretofore was crowded due to the toggle element or device. Moreover, the vehicle electrical wires or an electrical wire harness of the vehicle may be routed down from the headliner or overhead console of the vehicle and along the mounting arm of the support structure (such as within the mounting arm or along an external surface of the mounting arm) and to the generally centrally located electrical connector at or near the mounting ball. The electrical connection to the mirror assembly thus is close to the end of the mounting arm and avoids having to route the vehicle wiring toward the side of the mirror assembly as is conventionally done for mirror assemblies that typically have the electrical connector toward one side of the mirror and remote from the mounting structure.

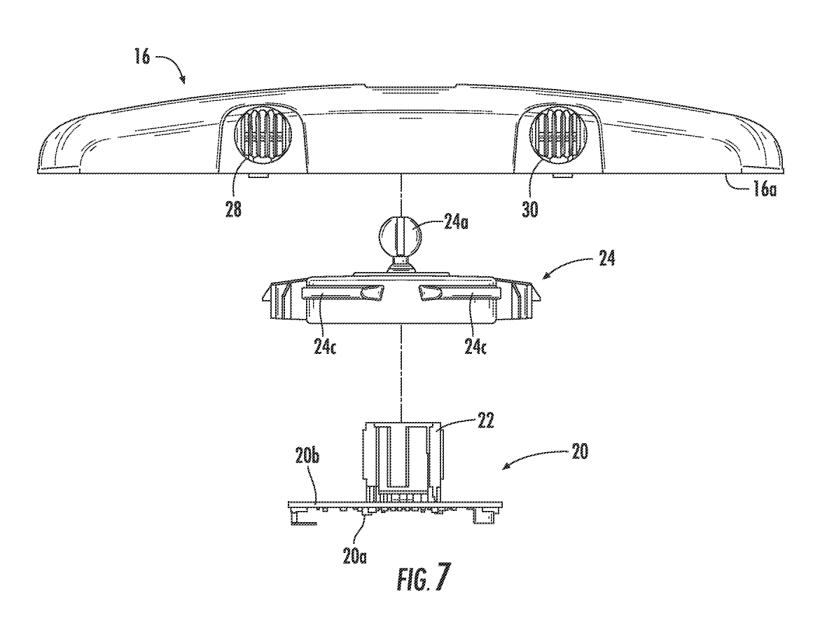

Optionally, the mirror assembly may also or otherwise include other accessories, such as microphones, such as analog microphones or digital microphones or the like, such as microphones of the types disclosed in U.S. Pat. Nos. 6,243,003; 6,278,377; and/or 6,420,975, and/or in U.S. patent application Ser. No. 10/529,715, filed Mar. 30, 2005 by Larson et al. for MICROPHONE SYSTEM FOR VEHICLE (Attorney Docket DON01 P-1111); and/or Ser. No. 11/861,904, filed Sep. 26, 2007 (Attorney Docket MAG04 P-1381), which are hereby incorporated herein by reference in their entireties. For example, in the illustrated embodiment, the mirror assembly 10 includes a microphone disposed at a microphone location 28 (FIG. 7) at an upper portion of casing 16. The microphone may comprise a modular element (with a cover element that may generally or substantially match the color and appearance of the mirror casing) that may snap-in or that is received into an aperture 16h formed at the upper portion of the mirror casing or that may snap in or otherwise be retained in the mirror casing. The microphone at microphone location 28 (such as a microphone disposed below a cover element that covers or spans the aperture 16h of mirror casing 16, and with the electrical connection between the microphone and the mirror circuitry being established within the mirror assembly) may function to receive audible or vocal sounds, such as from the driver of the vehicle, and may provide a signal indicative of the received sounds to a control or circuitry of a telematics system or a navigation system or the like, or may provide a signal indicative of the received sounds to a control or circuitry to provide a voice activating input to an associated system or device.

Optionally, and desirably, the microphone may be disposed at a driver side microphone location 28 of the mirror assembly when the mirror assembly is mounted in a vehicle (such as at or near or attached to a microphone cover element that generally matches the color and appearance of the mirror casing and that may protrude upward above an upper surface of the mirror casing and that may have apertures or slots established therethrough for allowing the microphone to receive sound signals from within the cabin of the vehicle). In order to maintain a uniform appearance for the mirror assembly, it is envisioned that a second “dummy” or surrogate microphone location 30 may be established at the passenger side of the mirror assembly. The second non-functional microphone location 30 may include a raised plastic microphone cover element (that is similar in appearance to the cover element at microphone location 28) that may be snapped into an opening or aperture at the passenger side of the upper portion of the mirror casing or the cover element may be integrally molded with the casing at surrogate microphone location 30. The surrogate microphone location or cover element is established principally for providing an aesthetically pleasing, symmetrical or uniform appearance to a person viewing the mirror assembly when the mirror assembly is normally mounted in the vehicle.

Optionally, a vehicle navigation system may be integrated with the mirror system and mirror assembly. The navigation device may include navigational circuitry and a GPS antenna to determine the geographical location of the vehicle and to provide routes to targeted or selected destinations, such as by utilizing aspects of known navigational devices and/or the devices of the types described in U.S. Pat. Nos. 4,862,594; 4,937,945; 5,131,154; 5,255,442; 5,632,092; 5,798,688; 5,971,552; 5,924,212; 6,243,003; 6,278,377; 6,420,975; 6,946,978; 6,477,464; 6,678,614; 7,308,341; and/or 7,004,593, and/or U.S. patent application Ser. No. 10/645,762, filed Aug. 20, 2003 by Taylor et al. for VEHICLE NAVIGATION SYSTEM FOR USE WITH A TELEMATICS SYSTEM, now U.S. Pat. No. 7,167,796; Ser. No. 10/529,715, filed Mar. 30, 2005 by Larson et al. for MICROPHONE SYSTEM FOR VEHICLE (Attorney Docket DON01 P-1111); Ser. No. 10/538,724, filed Jun. 13, 2005 by Hutzel et al. for ACCESSORY SYSTEM FOR VEHICLE (Attorney Docket DON01 P-1123); and/or Ser. No. 11/861,904, filed Sep. 26, 2007 (Attorney Docket MAG04 P-1381), which are all hereby incorporated herein by reference in their entireties. Optionally, the mirror or navigation device may include a microphone or may be associated with the mirror microphone 28, whereby the mirror or navigation device may provide voice activated control of the navigation device.

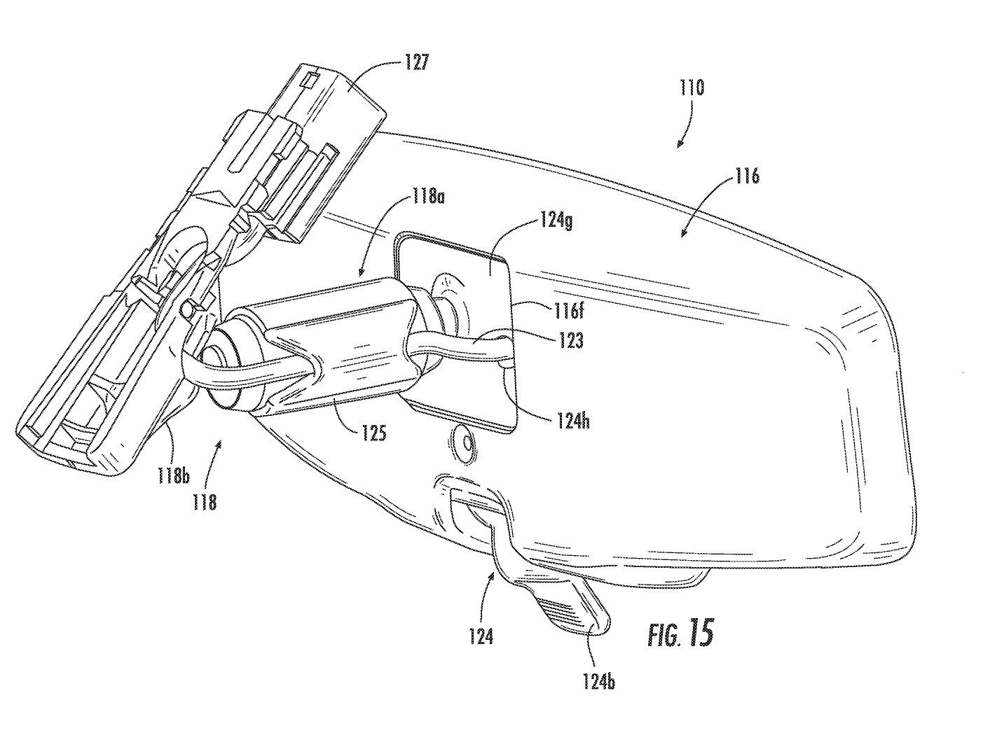

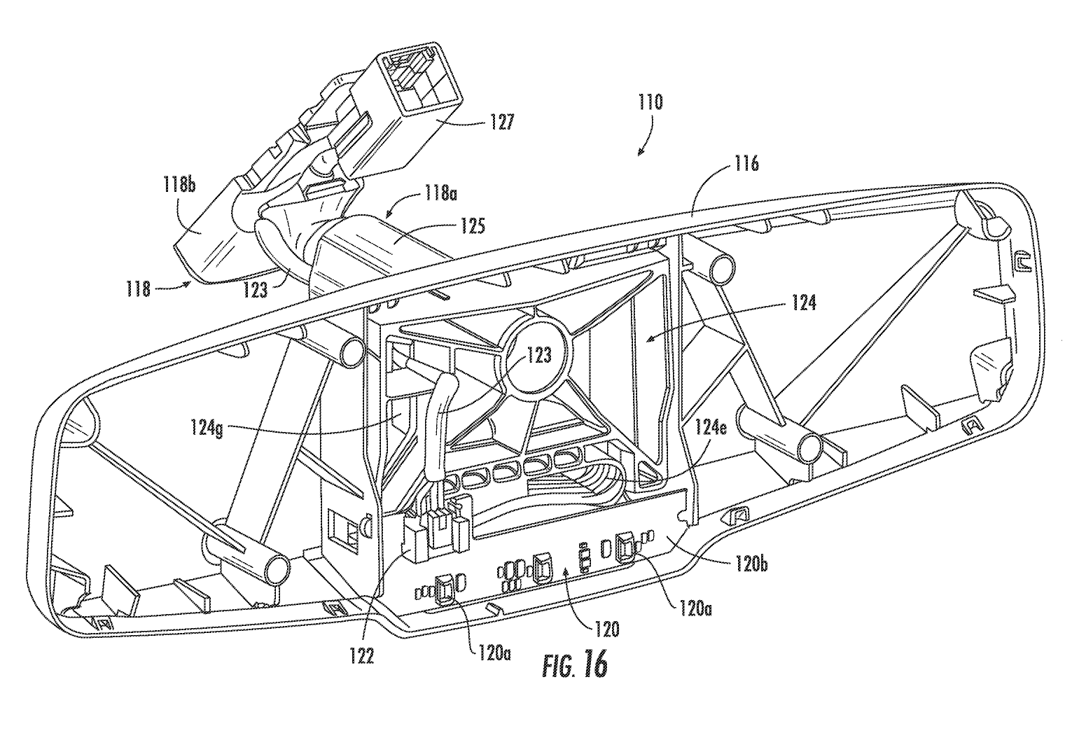

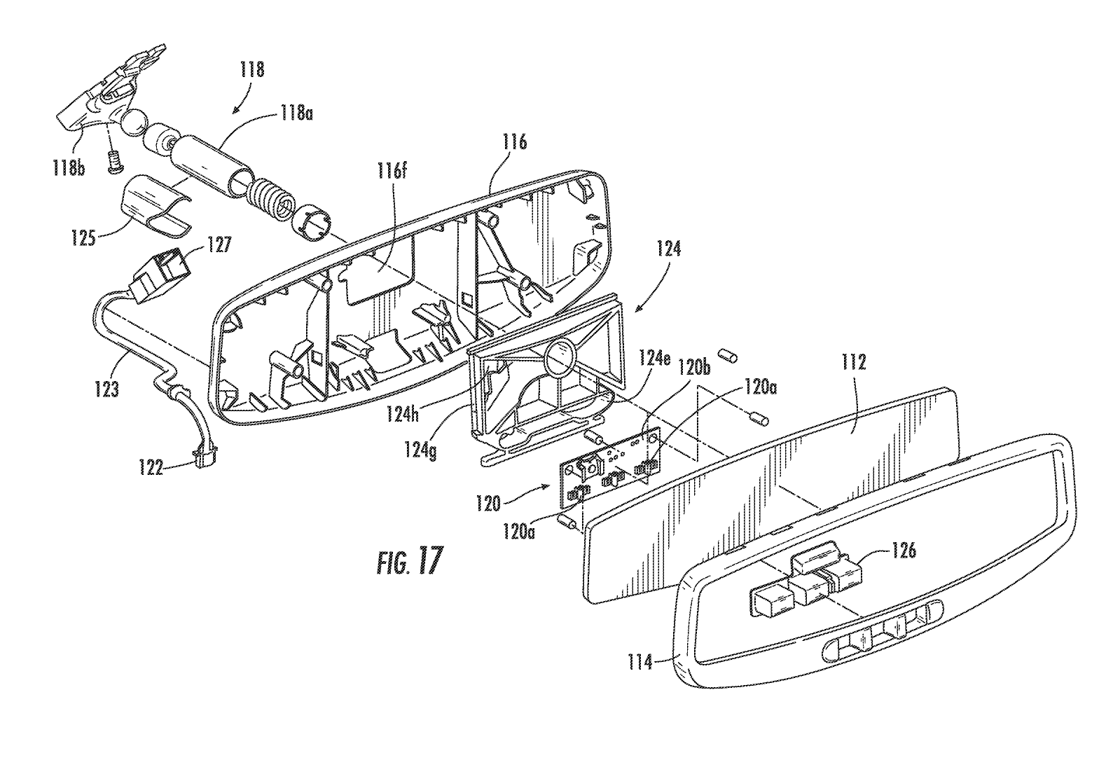

Optionally, and with reference to FIGS. 15-17, an interior rearview mirror assembly 110 includes a prismatic reflective element 112, a bezel portion 114 that receives and/or supports the reflective element 112, a rear casing or housing portion 116 and a mounting structure 118, such as a double ball mounting structure that movably and adjustably supports the mirror assembly and reflective element at the interior portion of the vehicle. The mirror assembly 110 includes electrical circuitry 120 (FIG. 16), which includes or is electrically connected to an electrical connector 122, which is disposed at or near a generally central location at the rear casing 116, whereby an electrical wire or wiring harness or lead 123 is routed along the mounting arm 118a and is connected to the electrical connector 122 generally at and/or below the mounting structure 118 of the mirror assembly, as discussed below.

The wire or lead 123 extends through a body portion 124g of toggle device 124 that is adjustable (via a toggle tab or actuator 124b) by a user to adjust the mirror reflective element between a day state orientation or higher reflectivity orientation and a night state orientation or lower reflectivity orientation. The toggle device 124 may be otherwise substantially similar to toggle device 24, discussed above, such that a detailed discussion of the toggle devices need not be repeated herein. In the illustrated embodiment, the wire or wiring harness or lead or cable 123 is routed through an aperture 116f at the rear wall of mirror casing 116 and through an aperture or hole 124h formed or established through the body portion 124g of toggle device 124. The wiring harness 123 is routed within casing 116 and along body portion 124g to connector 122, which connects to circuitry element 120 (such as to a corresponding connector at a substrate or board 120b of circuitry element 120). The connector 122 may comprise any suitable connector, such as a multi-pin plug or socket type connector that connects or plugs into or receives a corresponding multi-pin socket or plug type connector at the circuitry element 120. Because the connector 122 is not received through the biasing member or flexible loop 124e of toggle device 124, the biasing member 124e and body portion 124g of toggle device 124 may be different shaped than biasing member 24e and body portion 24g of toggle device 24, discussed above, and may utilize aspects of the toggle devices described in U.S. Pat. No. 6,318,870, which is hereby incorporated herein by reference in its entirety.

In the illustrated embodiment, the mounting structure 118 comprises a double ball mounting structure, and the toggle device 124 includes a ball member 124a that is pivotally received in a mounting arm 118a of mounting structure 118 that is in turn pivotally connected to or mounted to a ball member or base 118b attached to a mounting button or element at the interior surface of the windshield. Wiring harness 123 is routed along mounting arm 118a, such as along and within a retaining element 125 that receives the wire between a channel of the retaining element and the outer surface of the mounting arm (such as a retaining element or clip of the types described in U.S. Pat. No. 6,540,193, which is hereby incorporated herein by reference in its entirety). The wire is mounted into the base member 118b and upward along the windshield of the vehicle when the mirror assembly is mounted to the windshield of the vehicle. The mirror assembly and/or vehicle may include additional wire management elements or structure to route and conceal the wire along the windshield and between the mirror mount and the headliner or overhead console of the vehicle, such as by utilizing aspects of the mirror systems described in U.S. patent application Ser. No. 11/226,628, filed Sep. 14, 2005 (Attorney Docket DON01 P-1236), which is hereby incorporated herein by reference in its entirety. The upper end of wire harness 123 includes a connector 127 for connecting to a corresponding connector of a vehicle wire harness at the headliner or overhead console of the vehicle.

When the toggle device is received in or mounted at the mirror casing, the electrical connector passes through the aperture of the toggle device and through or at least partially through the aperture at the rear wall of the mirror casing. Thus, and as can be seen with reference to FIG. 17, the circuit element or circuit board is at least partially disposed between the toggle device and the rear surface of the mirror reflective element. The connector extends from the circuit element through the apertures so as to be accessible at the rear of the mirror casing for electrical connection thereto.

Thus, the mirror assembly 110 provides an electrical connector that extends through the toggle device and through the rear casing so as to provide for electrical connection at a generally central location at the rear of the mirror casing and generally below the mounting ball of the mirror assembly. Also, the circuit board or element may be disposed generally centrally within the mirror assembly, and thus may be located with the electrical circuitry or switches 120a behind user inputs or buttons 126 (FIG. 17) at the generally central region of the mirror (such as at a lower or chin region of the bezel portion 114), without requiring a separate leg or extension of the circuit board toward a side of the mirror assembly to connect to a sidewardly positioned connector of the prior art. The mirror assembly thus provides a generally centrally located circuit element and connector in a location that heretofore was crowded due to the toggle element or device. Moreover, the vehicle electrical wires or an electrical wire harness of the vehicle may be routed down from the headliner or overhead console of the vehicle and along the mounting arm of the support structure (such as within the mounting arm or along an external surface of the mounting arm) and to the generally centrally located electrical connector at or near the mounting ball. The electrical connection to the mirror assembly thus is close to the end of the mounting arm and avoids having to route the vehicle wiring toward the side of the mirror assembly as is conventionally done for mirror assemblies that typically have the electrical connector toward one side of the mirror and remote from the mounting structure.

In the illustrated embodiments, the mirror assembly comprises a prismatic mirror assembly, such as a prismatic mirror assembly utilizing aspects described in U.S. Pat. Nos. 7,289,037; 7,249,860; 6,318,870; 6,598,980; 5,327,288; 4,948,242; 4,826,289; 4,436,371; and 4,435,042; and PCT Application No. PCT/US04/015424, filed May 18, 2004 by Donnelly Corporation et al. for MIRROR ASSEMBLY FOR VEHICLE, which are hereby incorporated herein by reference in their entireties. Optionally, the prismatic reflective element may comprise a conventional prismatic reflective element or prism, or may comprise a prismatic reflective element of the types described in U.S. Pat. Nos. 7,274,501; 7,420,756; 7,249,860; 7,255,451; 7,338,177, which are all hereby incorporated herein by reference in their entireties.

Such prismatic mirror reflective elements may be formed from various materials such as plastic or glass, and typically have a planar front surface extending at an angle to a planar rear surface. The rear surface is coated with a reflective layer of metal (such as chromium, aluminum or alloys thereof or other suitable materials) as is conventionally known in the industry. The reflective element is pivotable relative to a mounting assembly of the mirror to pivot the reflective surface in order to reduce glare during nighttime conditions. When the reflective element is pivoted from a full reflectivity day position to a reduced reflectivity night position, the reflective surface is rotated such that uncoated front surface is aligned for viewing by the vehicle driver instead of reflective surface. Preferably, the reflective surface reflects at least about 60 percent to about 95 percent of the light incident thereon, while the uncoated front surface reflects a reduced amount of light, such as about 4 percent of the light incident thereon, thereby significantly reducing glare from headlights or other bright lights to the rear of the vehicle to the driver's eyes.

Optionally, the mirror reflective element may comprise a frameless reflective element, such as by utilizing aspects of the reflective elements described in U.S. Pat. Nos. 7,360,932; 7,255,451; 7,274,501; and/or 7,184,190, and/or PCT Application No. PCT/US2006/018567, filed May 15, 2006 by Donnelly Corp. et al.; PCT Application No. PCT/US2004/015424, filed May 18, 2004 by Donnelly Corp. et al. for MIRROR ASSEMBLY FOR VEHICLE, and published on Dec. 2, 2004, as International Publication No. WO 2004/10377282; and/or U.S. patent application Ser. No. 11/912,576, filed Oct. 25, 2007 (Attorney Docket DON01 P-1274); Ser. No. 11/226,628, filed Sep. 14, 2005 (Attorney Docket DON01 P-1236); and/or Ser. No. 10/538,724, filed Jun. 13, 2005 (Attorney Docket DON01 P-1123), which are hereby incorporated herein by reference in their entireties. Optionally, the reflective element may include a metallic perimeter band around the perimeter of the reflective element, such as by utilizing aspects of the reflective elements described in U.S. Pat. Nos. 7,274,501; 7,184,190; and/or 7,255,451, PCT Application No. PCT/US2006/018567, filed May 15, 2006 by Donnelly Corp. et al.; PCT Application No. PCT/US03/29776, filed Sep. 19, 2003 by Donnelly Corp. et al. for ELECTROCHROMIC MIRROR ASSEMBLY; and/or PCT Application No. PCT/US03/35381, filed Nov. 5, 2003 by Donnelly Corp. et al. for ELECTRO-OPTIC REFLECTIVE ELEMENT ASSEMBLY, and/or U.S. patent application Ser. No. 11/912,576, filed Oct. 25, 2007 (Attorney Docket DON01 P-1274); and/or Ser. No. 11/226,628, filed Sep. 14, 2005 by Karner et al. for MOUNTING ASSEMBLY FOR VEHICLE INTERIOR MIRROR (Attorney Docket DON01 P-1236), which is hereby incorporated herein by reference in their entireties.

Optionally, aspects of the mirror assembly may be incorporated into a mirror assembly having a mirror reflective element that comprises an electrically variable reflectance mirror reflector, such as an electro-optic reflective element assembly or cell, such as an electrochromic reflective element assembly or cell. For example, the rearview mirror assembly may comprise an electro-optic or electrochromic reflective element or cell, such as an electrochromic mirror assembly and electrochromic reflective element utilizing principles disclosed in commonly assigned U.S. Pat. Nos. 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407; 4,824,221; 5,818,636; 6,166,847; 6,111,685; 6,392,783; 6,710,906; 6,798,556; 6,554,843; 6,420,036; 5,142,406; 5,442,478; 7,195,381; 7,255,451; 7,274,501; 7,184,190; 7,338,177; 7,370,983; and/or 4,712,879, and/or U.S. pat. application Ser. No. 10/538,724, filed Jun. 13, 2005 by Hutzel et al. for ACCESSORY SYSTEM FOR VEHICLE (Attorney Docket DON01 P-1123); and/or Ser. No. 11/226,628, filed Sep. 14, 2005 by Karner et al. (Attorney Docket DON01 P-1236), and/or International Pat. Publication Nos. WO 2004/098953, published Nov. 18, 2004; WO 2004/042457, published May 21, 2004; WO 2003/084780, published Oct. 16, 2003; and/or WO 2004/026633, published Apr. 1, 2004, which are all hereby incorporated herein by reference in their entireties, and/or such as disclosed in the following publications: N. R. Lynam, “Electrochromic Automotive Day/Night Mirrors”, SAE Technical Paper Series 870636 (1987); N. R. Lynam, “Smart Windows for Automobiles”, SAE Technical Paper Series 900419 (1990); N. R. Lynam and A. Agrawal, “Automotive Applications of Chromogenic Materials”, Large Area Chromogenics: Materials and Devices for Transmittance Control, C. M. Lampert and C. G. Granquist, EDS., Optical Engineering Press, Wash. (1990), which are hereby incorporated herein by reference in their entireties.

Optionally, use of an elemental semiconductor mirror, such as a silicon metal mirror, such as disclosed in U.S. Pat. Nos. 6,286,965; 6,196,688; 5,535,056; 5,751,489; 7,338,177; and 6,065,840, which are all hereby incorporated herein by reference in their entireties, can be advantageous because such elemental semiconductor mirrors (such as can be formed by depositing a thin film of silicon) can be greater than 50 percent reflecting in the photopic (SAE J964a measured), while being also substantially transmitting of light (up to 20 percent or even more). Such silicon mirrors also have the advantage of being able to be deposited onto a flat glass substrate and to be bent into a curved (such as a convex or aspheric) curvature, which is also advantageous since many passenger-side exterior rearview mirrors are bent or curved.

Optionally, the mounting structure and/or mirror casing may support one or more imaging sensors or cameras, and may fixedly support them with the cameras set with a desired or appropriate forward and/or rearward field of view. For example, the camera may be operable in conjunction with a forward facing imaging system, such as a rain sensing system, such as described in U.S. Pat. Nos. 6,968,736; 6,806,452; 6,516,664; 6,353,392; 6,313,454; 6,250,148; 6,341,523; and 6,824,281, and in U.S. patent application Ser. No. 10/958,087, filed Oct. 4, 2004 by Schofield et al. for VEHICLE ACCESSORY MODULE, now U.S. Pat. No. 7,188,963; and/or Ser. No. 11/201,661, filed Aug. 11, 2005 by DeWard et al. for ACCESSORY MODULE FOR VEHICLE, now U.S. Pat. No. 7,480,149, which are all hereby incorporated herein by reference in their entireties. The mounting structure and/or mirror casing (and/or optionally a windshield electronics module or accessory module at or near or associated with the mirror assembly and generally at the windshield) may be pressed or loaded against the interior surface of the windshield to position or locate the image sensor in close proximity to the windshield and/or to optically couple the image sensor at the windshield. The mounting structure and/or mirror casing may include an aperture or apertures at its forward facing or mounting surface and the windshield may include apertures through the opaque frit layer (typically disposed at a mirror mounting location of a windshield) or the windshield may not include such a frit layer, depending on the particular application.

Optionally, the image sensor may be operable in conjunction with a forward or rearward vision system, such as an automatic headlamp control system and/or a lane departure warning system or object detection system and/or other forward vision or imaging systems, such as imaging or vision systems of the types described in U.S. Pat. Nos. 7,339,149; 7,038,577; 7,005,974; 7,004,606; 6,690,268; 6,946,978; 6,757,109; 6,717,610; 6,396,397; 6,201,642; 6,353,392; 6,313,454; 5,550,677; 5,670,935; 5,796,094; 5,715,093; 5,877,897; 6,097,023; and 6,498,620, and/or U.S. patent application Ser. No. 10/422,512, filed Apr. 24, 2003, now U.S. Pat. No. 7,123,168; Ser. No. 11/239,980, filed Sep. 30, 2005 (Attorney Docket DON01 P-1238); Ser. No. 11/672,070, filed Feb. 7, 2007 (Attorney Docket DON01 P-1320); and/or Ser. No. 11/315,675, filed Dec. 22, 2005 by Higgins-Luthman for OBJECT DETECTION SYSTEM FOR VEHICLE (Attorney Docket DON01 P-1253), and/or U.S. provisional applications, Ser. No. 60/628,709, filed Nov. 17, 2004 by Camilleri et al. for IMAGING AND DISPLAY SYSTEM FOR VEHICLE; Ser. No. 60/614,644, filed Sep. 30, 2004; Ser. No. 60/618,686, filed Oct. 14, 2004 by Laubinger for VEHICLE IMAGING SYSTEM; Ser. No. 60/731,183, filed Oct. 28, 2005 by Gibson for CAMERA MODULE FOR VEHICLE VISION SYSTEM; and/or Ser. No. 60/765,797, filed Feb. 7, 2006, which are hereby incorporated herein by reference in their entireties. The mirror casing thus may support one or more rearward facing imaging sensors or cameras, such as for rearward vision or imaging systems, such as for a rear vision system or back up aid of the types described in U.S. Pat. Nos. 6,717,610 and/or 6,201,642 (which are hereby incorporated herein by reference in their entireties), and/or a cabin monitoring system or baby view system of the types described in U.S. Pat. No. 6,690,268 (which is hereby incorporated herein by reference in its entirety), and/or the like.

Optionally, the mirror assembly may include a display element or screen for displaying information to the driver or occupant of the vehicle. The display element may comprise any suitable display element or device, such as, for example, a video display element or device or the like, and may be a display-on-demand or transflective type display or other display, such as by utilizing aspects of the displays described in U.S. Pat. Nos. 7,370,983; 7,274,501; 7,255,451; 7,184,190; 6,690,268; 5,668,663 and/or 5,724,187, and/or U.S. patent application Ser. No. 10/538,724, filed Jun. 13, 2005 by Hutzel et al. for ACCESSORY SYSTEM FOR VEHICLE (Attorney Docket DON01 P-1123); Ser. No. 11/226,628, filed Sep. 14, 2005 by Karner et al. (Attorney Docket DON01 P-1236); Ser. No. 11/912,576, filed Oct. 25, 2007 (Attorney Docket DON01 P-1274); and/or Ser. No. 11/861,904, filed Sep. 26, 2007 (Attorney Docket MAG04 P-1381), and/or PCT Patent Application No. PCT/US2006/018567, filed May 15, 2006 by Donnelly Corp. et al., which are all hereby incorporated herein by reference in their entireties, or may include or incorporate video displays or the like, such as the types described in U.S. Pat. Nos. 7,370,983; 7,274,501; 7,255,451; 7,184,190; and/or 6,690,268 and/or U.S. patent applications, Set. No. 10/538,724, filed Jun. 13, 2005 (Attorney Docket DON01 P-1123); and/or Ser. No. 12/091,525, filed Apr. 25, 2008 (Attorney Docket DON01 P-1300), and/or PCT Application No. PCT/US2006/042718, filed Oct. 31, 2006; and U.S. provisional applications, Ser. No. 60/836,219, filed Aug. 8, 2006; Ser. No. 60/759,992, filed Jan. 18, 2006; and/or Ser. No. 60/732,245, filed Nov. 1, 2005, which are hereby incorporated herein by reference in their entireties. Optionally, the mirror assembly may include a video display that is selectively positionable, such as extendable/retractable or pivotable or foldable so as to be selectively positioned at a side or below the mirror casing when in use and storable within or at least partially within the mirror casing when not in use. The display may be automatically activated and/or may automatically extend/pivot to an in-use position in response to an actuating event, such as when the playback device is activated (and/or optionally, when the display is associated with a rearward vision system or back up aid, when the vehicle is shifted into its reverse gear).

Optionally, the mirror assembly may include one or more user inputs for controlling or activating/deactivating one or more electrical accessories or devices of or associated with the mirror assembly. For example, the mirror assembly may comprise any type of switches or buttons, such as touch or proximity sensing switches, such as touch or proximity switches of the types described in PCT Application No. PCT/US03/40611, filed Dec. 19, 2003 by Donnelly Corporation for ACCESSORY SYSTEM FOR VEHICLE; and/or PCT Application No. PCT/US2004/015424, filed May 18, 2004 by Donnelly Corp. et al. for MIRROR ASSEMBLY FOR VEHICLE, and/or U.S. Pat. Nos. 7,360,932; 7,255,451; 7,249,860; 7,224,324; 6,001,486; 6,310,611; 6,320,282; and 6,627,918; and/or U.S. patent application Ser. No. 10/956,749, filed Oct. 1, 2004 by Schofield et al. for MIRROR REFLECTIVE ELEMENT ASSEMBLY INCLUDING ELECTRONIC COMPONENT, now U.S. Pat. No. 7,446,924, which are hereby incorporated herein by reference in their entireties, or the inputs may comprise other types of buttons or switches, such as those described in U.S. Pat. No. 6,501,387, and/or U.S. pat. application Ser. No. 11/029,695, filed Jan. 5, 2005, now U.S. Pat. No. 7,253,723; and/or Ser. No. 11/451,639, filed Jun. 13, 2006 by Uken for MIRROR ASSEMBLY FOR VEHICLE, now U.S. Pat. No. 7,527,403, which are hereby incorporated herein by reference in their entireties, or such as fabric-made position detectors, such as those described in U.S. Pat. Nos. 6,504,531; 6,501,465; 6,492,980; 6,452,479; 6,437,258; and 6,369,804, which are hereby incorporated herein by reference in their entireties. Other types of switches or buttons or inputs or sensors may be incorporated to provide the desired function, without affecting the scope of the present invention. The manual inputs or user actuatable inputs or actuators may control or adjust or activate/deactivate one or more accessories or elements or features. For touch sensitive inputs or applications or switches, the mirror assembly or accessory module or input may, when activated, provide a positive feedback (such as activation of an illumination source or the like, or such as via an audible signal, such as a chime or the like, or a tactile or haptic signal, or a rumble device or signal or the like) to the user so that the user is made aware that the input was successfully activated.

Optionally, the user inputs or buttons may comprise user inputs for a garage door opening system, such as a vehicle based garage door opening system of the types described in U.S. Pat. Nos. 7,023,322; 6,396,408; 6,362,771; and 5,798,688, which are hereby incorporated herein by reference in their entireties. The user inputs may also or otherwise function to activate and deactivate a display or function or accessory, and/or may activate/deactivate and/or commence a calibration of a compass system of the mirror assembly and/or vehicle. Optionally, the user inputs may also or otherwise comprise user inputs for a telematics system of the vehicle, such as, for example, an ONSTAR® system as found in General Motors vehicles and/or such as described in U.S. Pat. Nos. 4,862,594; 4,937,945; 5,131,154; 5,255,442; 5,632,092; 5,798,688; 5,971,552; 5,924,212; 6,243,003; 6,278,377; 6,420,975; 6,946,978; 6,477,464; 6,678,614; 7,308,341; and/or 7,004,593, and/or U.S. patent application Ser. No. 10/645,762, filed Aug. 20, 2003 by Taylor et al. for VEHICLE NAVIGATION SYSTEM FOR USE WITH A TELEMATICS SYSTEM, now U.S. Pat. No. 7,167,796; Ser. No. 10/529,715, filed Mar. 30, 2005 by Larson et al. for MICROPHONE SYSTEM FOR VEHICLE (Attorney Docket DON01 P-1111); and/or Ser. No. 10/538,724, filed Jun. 13, 2005 by Hutzel et al. for ACCESSORY SYSTEM FOR VEHICLE (Attorney Docket DON01 P-1123), which are all hereby incorporated herein by reference in their entireties.

Optionally, the display and/or inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 6,877,888; 6,690,268; 6,824,281; 6,672,744; 6,386,742; and 6,124,886, and/or PCT Application No. PCT/US03/40611, filed Dec. 19, 2003 by Donnelly Corporation for ACCESSORY SYSTEM FOR VEHICLE, and/or PCT Application No. PCT/US04/15424, filed May 18, 2004 by Donnelly Corporation et al. for MIRROR ASSEMBLY FOR VEHICLE, and/or U.S. patent application Ser. No. 10/510,813, filed Aug. 23, 2002 by Berberich et al. for COVER MODULE, now U.S. Patent Application Publication No. US2005/0151396A1, published Jul. 14, 2005, which are hereby incorporated herein by reference in their entireties.

Optionally, the mirror assembly or accessory module may fixedly or non-movably support one or more other accessories or features, such as one or more electrical or electronic devices or accessories. For example, illumination sources or lights, such as map reading lights or one or more other lights or illumination sources, such as illumination sources of the types disclosed in U.S. Pat. Nos. 6,690,268; 5,938,321; 5,813,745; 5,820,245; 5,673,994; 5,649,756; 5,178,448; 5,671,996; 4,646,210; 4,733,336; 4,807,096; 6,042,253; 6,971,775; and/or 5,669,698, and/or U.S. patent application Ser. No. 10/054,633, filed Jan. 22, 2002, now U.S. Pat. No. 7,195,381; and/or Ser. No. 10/933,842, filed Sep. 3, 2004 by Kulas et al. for INTERIOR REARVIEW MIRROR ASSEMBLY, now U.S. Pat. No. 7,249,860, which are hereby incorporated herein by reference in their entireties, may be included in the mirror assembly. The illumination sources and/or the circuit board may be connected to one or more buttons or inputs for activating and deactivating the illumination sources.

Optionally, the mirror assembly may also or otherwise include other accessories, such as a telematics system, speakers, antennas, including global positioning system (GPS) or cellular phone antennas, such as disclosed in U.S. Pat. No. 5,971,552, a communication module, such as disclosed in U.S. Pat. No. 5,798,688, a voice recorder, a blind spot detection and/or indication system, such as disclosed in U.S. Pat. Nos. 7,038,577; 6,882,287; 5,929,786 and/or 5,786,772, and/or U.S. patent application Ser. No. 11/315,675, filed Dec. 22, 2005 by Higgins-Luthman for OBJECT DETECTION SYSTEM FOR VEHICLE (Attorney Docket DON01 P-1253); and/or PCT Application No. PCT/US2006/026148, filed Jul. 5, 2006 for VEHICLE EXTERIOR MIRROR ASSEMBLY WITH BLIND SPOT INDICATOR, transmitters and/or receivers, such as for a garage door opener or a vehicle door unlocking system or the like (such as a remote keyless entry system), a digital network, such as described in U.S. Pat. No. 5,798,575, a hands-free phone attachment, an imaging system or components or circuitry or display thereof, such as an imaging and/or display system of the types described in U.S. Pat. Nos. 6,690,268; 7,400,435 and 6,847,487; and/or U.S. provisional applications, Ser. No. 60/614,644, filed Sep. 30, 2004; Ser. No. 60/618,686, filed Oct. 14, 2004; and/or Ser. No. 60/628,709, filed Nov. 17, 2004; and/or U.S. patent application Ser. No. 11/105,757, filed Apr. 14, 2005, now U.S. Pat. No. 7,526,103; and/or Ser. No. 11/239,980, filed Sep. 30, 2005 (Attorney Docket DON01 P-1238), a video device for internal cabin surveillance (such as for sleep detection or driver drowsiness detection or the like) and/or video telephone function, such as disclosed in U.S. Pat. Nos. 5,760,962 and/or 5,877,897, an occupant detection system and/or interior cabin monitoring system (such as the types described in U.S. Pat. Nos. 6,019,411 and/or 6,690,268, and/or PCT Application No. PCT/US2005/042504, filed Nov. 22, 2005 and published Jun. 1, 2006 as International Publication No. WO 2006/058098 A2; and/or PCT Application No. PCT/US94/01954, filed Feb. 25, 1994, a heating element, particularly for an exterior mirror application, such as the types described in U.S. Pat. No. 7,400,435, a compass system, such as, for example, compass sensors, such as compass sensors of the types described in may utilize aspects of the compass systems described in U.S. patent application Ser. No. 11/226,628, filed Sep. 14, 2005 (Attorney Docket DON01 P-1236); and/or U.S. Pat. Nos. 7,329,013; 6,922,902; 7,249,860; 7,370,983; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252; and 6,642,851, and/or PCT Application No. PCT/US2004/015424, filed May 18, 2004, and/or European patent Publication No. EP01043566, published Oct. 11, 2000, a remote keyless entry receiver, a seat occupancy detector, a remote starter control (such as a starter system utilizing aspects of U.S. provisional applications, Ser. No. 60/859,680, filed Nov. 17, 2006, and Ser. No. 60/944,917, filed Jun. 19, 2007, a yaw sensor, a clock, a carbon monoxide detector, status displays, such as displays that display a status of a door of the vehicle, a transmission selection (4 wd/2 wd or traction control (TCS) or the like), an antilock braking system, a road condition sensing system (that may warn the driver of icy road conditions and/or the like, such as black ice conditions, such as described in U.S. patent application Ser. No. 11/948,086, filed Nov. 30, 2007 (Attorney Docket MAG04 P-1389), and U.S. provisional application Ser. No. 60/872,270, filed Dec. 1, 2006), a trip computer, a tire pressure monitoring system (TPMS) receiver (such as described in U.S. Pat. Nos. 7,423,522; 6,124,647; 6,294,989; 6,445,287; 6,472,979; and/or 6,731,205, and/or an ONSTAR® system and/or any other accessory or circuitry or the like (with all of the above-referenced U.S. patents and PCT applications and U.S. patent applications and U.S. provisional applications being commonly assigned to Donnelly Corporation, and with the disclosures of the referenced U.S. patents and PCT applications and U.S. patent applications and U.S. provisional applications being hereby incorporated herein by reference in their entireties).

Changes and modifications to the specifically described embodiments may be carried out without departing from the principles of the present invention, which is intended to be limited only by the scope of the appended claims as interpreted according to the principles of patent law.

1. An interior rearview mirror assembly suitable for use in a vehicle, said interior rearview mirror assembly comprising:
a mirror casing, said mirror casing having a first aperture formed through a generally central region of a rear wall of said mirror casing;
a prismatic reflective element at said mirror casing;
a toggle device at said mirror casing, said toggle device comprising a user actuatable element and being operable in response to said user actuatable element to pivot said prismatic reflective element between a day state orientation and a night state orientation, wherein said toggle device includes a second aperture therethrough;
a circuit element, said circuit element having electronic circuitry disposed on a substrate, said circuit element having an electrical connector extending from said substrate; and
wherein said electrical connector extends through said second aperture of said toggle device and is accessible through said first aperture at said generally central region of said rear wall of said mirror casing.

2. The interior rearview mirror assembly of claim 1, wherein said toggle device comprises a mounting member configured to adjustably mount said mirror assembly to a mounting structure attached to the vehicle, and wherein said mounting member is generally centrally located at said mirror casing.

3. The interior rearview mirror assembly of claim 2, wherein said mounting member extends through a third aperture formed through said rear wall of said mirror casing.

4. The interior rearview mirror assembly of claim 3, wherein said third aperture is established generally adjacent to said first aperture for receiving said electrical connector.

5. The interior rearview mirror assembly of claim 3, wherein said user actuatable element extends through a fourth aperture formed through a lower region of said mirror casing.

6. The interior rearview mirror assembly of claim 5, wherein said fourth aperture at least partially encompasses said rear wall of said mirror casing.

7. The interior rearview mirror assembly of claim 1, wherein said toggle device comprises a biasing element that comprises a flexible loop portion of said toggle device, and wherein said second aperture is established at said flexible loop portion.

8. The interior rearview mirror assembly of claim 1, wherein said circuit element is at least partially disposed between said toggle device and a rear surface of said prismatic reflective element.

9. An interior rearview mirror assembly suitable for use in a vehicle, said interior rearview mirror assembly comprising:
a mirror casing;
a prismatic reflective element at said mirror casing;
a toggle device at said mirror casing, said toggle device comprising a user actuatable element and being operable in response to said user actuatable element to pivot said prismatic reflective element between a day state orientation and a night state orientation;
a circuit element, said circuit element having electronic circuitry disposed on a substrate, said circuit element having an electrical connector extending from said substrate;
wherein said circuit element is at least partially disposed between said toggle device and a rear surface of said prismatic reflective element; and
wherein said electrical connector extends through a portion of said toggle device and is accessible through a generally central region of a rear wall of said mirror casing.

10. The interior rearview mirror assembly of claim 9, wherein said toggle device comprises a mounting member configured to adjustably mount said mirror assembly to a mounting structure attached to the vehicle, and wherein said mounting member is generally centrally located at said mirror casing.

11. The interior rearview mirror assembly of claim 10, wherein said mounting member extends through said rear wall of said mirror casing.

12. The interior rearview mirror assembly of claim 11, wherein said mounting member extends through said rear wall at a location that is generally adjacent to said electrical connector.

13. The interior rearview mirror assembly of claim 9, wherein said user actuatable element extends through a lower region of said mirror casing.

14. The interior rearview mirror assembly of claim 9, wherein said toggle device comprises a biasing element that comprises a flexible loop portion of said toggle device, said flexible loop portion being configured to receive said electrical connector therethrough.

15. An interior rearview mirror assembly suitable for use in a vehicle, said interior rearview mirror assembly comprising:
a mirror casing;
a prismatic reflective element at said mirror casing;
a toggle device at said mirror casing, said toggle device comprising a user actuatable element and being operable in response to said user actuatable element to pivot said prismatic reflective element between a day state orientation and a night state orientation;
a circuit element, said circuit element having electronic circuitry disposed on a substrate, said circuit element having an electrical connector extending from said substrate;
wherein said electrical connector comprises a plurality of terminals at a socket configured to receive a plug connector of a vehicle wire harness when said interior rearview mirror assembly is normally mounted in a vehicle;
wherein said circuit element is at least partially disposed between said toggle device and a rear surface of said prismatic reflective element;
wherein said electrical connector extends through a portion of said toggle device and is accessible through a generally central region of a rear wall of said mirror casing; and
wherein the plug connector of the vehicle wire harness accesses said socket at said generally central region of said rear wall of said mirror casing when the vehicle wire harness is electrically connected to said electrical connector of said circuit element.

16. The interior rearview mirror assembly of claim 15, wherein said toggle device comprises a mounting member configured to adjustably mount said mirror assembly to a mounting structure attached to the vehicle, and wherein said mounting member is generally centrally located at said mirror casing.

17. The interior rearview mirror assembly of claim 16, wherein said mounting member extends through said rear wall of said mirror casing.

18. The interior rearview mirror assembly of claim 17, wherein said mounting member extends through said rear wall at a location that is generally adjacent to said electrical connector.

19. The interior rearview mirror assembly of claim 15, wherein user actuatable element extends through a lower region of said mirror casing.

20. The interior rearview mirror assembly of claim 15, wherein said toggle device comprises a biasing element that comprises a flexible loop portion of said toggle device, said flexible loop portion being configured to receive said electrical connector therethrough.
